(19) United States
(12) Patent Application Publication
(10) Pub. No.: US 2024/0237014 A1
(43) Pub. Date: Jul. 11, 2024

(54) SYSTEMS AND METHODS FOR RESOURCE CONFIGURATION FOR NETWORK NODES

(71) Applicant: ZTE Corporation, Shenzhen (CN)

(72) Inventors: Hanqing XU, Shenzhen (CN); Nan ZHANG, Shenzhen (CN); Ziyang LI, Shenzhen (CN); Wei CAO, Shenzhen (CN); Shuang ZHENG, Shenzhen (CN)

(73) Assignee: ZTE Corporation, Shenzhen (CN)

(21) Appl. No.: 18/615,624

(22) Filed: Mar. 25, 2024

Related U.S. Application Data
(63) Continuation of application No. PCT/CN2022/090041, filed on Apr. 28, 2022.

(51) Int. Cl. H04W 72/23; H04W 72/044

(52) U.S. Cl. CPC H04W 72/23; H04W 72/046

(57) ABSTRACT

Presented are systems and methods for resource configuration for network nodes. A network node may receive configuration information for a plurality of first common channels received from a wireless communication node or a wireless communication device. The network node may forward one or more second common channels based on the configuration information.

### CROSS-REFERENCE TO RELATED APPLICATION

This application claims the benefit of priority under 35 U.S.C. § 120 as a continuation of International Patent Application No. PCT/CN2022/090041, filed on Apr. 28, 2022, the disclosure of which is incorporated herein by reference in its entirety.

### TECHNICAL FIELD

The disclosure relates generally to wireless communications, including but not limited to systems and methods for resource configuration for network nodes.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A network node may receive configuration information for a plurality of first common channels received from a wireless communication node (e.g., a ground terminal, a base station, a gNB, an eNB, or a serving node) or a wireless communication device (e.g., a user equipment). The network node may forward one or more second common channels based on the configuration information.

In some embodiments, the network node may receive the configuration information from the wireless communication node through a signalling comprising at least one of: system information, a Radio Resource Control (RRC) signalling, a medium access control control element (MAC CE) signaling, or a Downlink Control Information (DCI) signalling. The signalling, through one or more bitmaps, may indicate that the one or more second common channels can be a subset of the plurality of first common channels. The signalling, through one or more bitmaps, may indicate that the one or more second common channels each may correspond to at least one of: a best downlink transmission beam from the wireless communication node to the network node, one of the first common channels associated with a Physical Random Access Channel (PRACH) transmitted by the network node, or a best downlink transmission beam from the wireless communication node to the network node identified by the network node. The signalling, through one or more bitmaps, may indicate that one or more second common channels can be excluded from the first common channels.

In some embodiments, the one or more second common channels may represent all the first common channels. The network node may forward the one or more second common channels within each of a plurality of periods, wherein the periods each may correspond to a half frame containing the first common channels. The network node may forward the one or more second common channels within each period using a respective beam. The beam can be associated with an index determined based on a system frame number, the period, and a number of frames. The beam can be configured by the wireless communication node or an operations administration and maintenance (OAM) unit.

In some embodiments, the network node may determine the one or more second common channels based on comparing respective measurement results of the first common channels with a threshold value, wherein the threshold value can be configured by the wireless communication node or an OAM unit. The network node may determine the one or more second common channels based on respective measurement results of the first common channels. The network node may determine a plurality of beams to forward the one or more second common channels, respectively, wherein indices of the plurality of beams may correspond to indices of the one or more second common channels arranged in an ascending order, respectively.

In some embodiments, the network node may determine a plurality of beams to forward the one or more second common channels, respectively, wherein indices of the plurality of beams can be identical to indices of the one or more second common channels, respectively. The network node may use a plurality of beams to forward the one or more second common channels, respectively, wherein indices of the plurality of beams can be configured by the wireless communication node or an OAM unit. The network node may use a single beam to forward a subset of the one or more second common channels. The network node may one or more beams to forward a corresponding one of the one or more second common channels. The network node may use a plurality of narrow or wide beams to forward the one or more second common channels, respectively.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a block diagram of an example transmission links between a base station (BS) to a network node and a network node to a user equipment (UE), in accordance with some embodiments of the present disclosure;

FIG. 4 illustrates a block diagram of an example network node beam capability, in accordance with some embodiments of the present disclosure;

FIG. 5 illustrates a data structure of an example resource configuration for network nodes, in accordance with some embodiments of the present disclosure;

FIG. 6 illustrates a data structure of an example resource configuration for network nodes, in accordance with some embodiments of the present disclosure;

FIG. 7 illustrates a data structure of an example resource configuration for network nodes, in accordance with some embodiments of the present disclosure;

FIG. 8 illustrates a data structure of an example determination of a network node forwarding beam, in accordance with some embodiments of the present disclosure; and

FIG. 9 illustrates a flow diagram of an example method for resource configuration for network nodes, in accordance with an embodiment of the present disclosure.

### DETAILED DESCRIPTION

### 1. Mobile Communication Technology and Environment

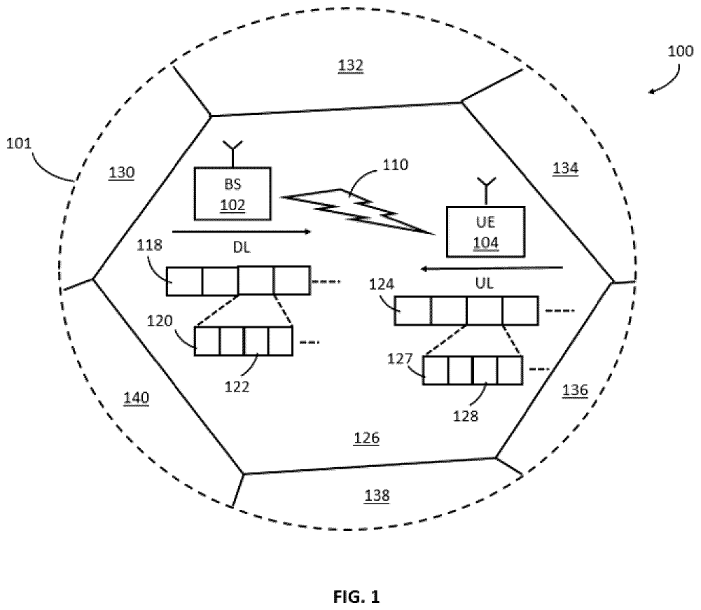

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

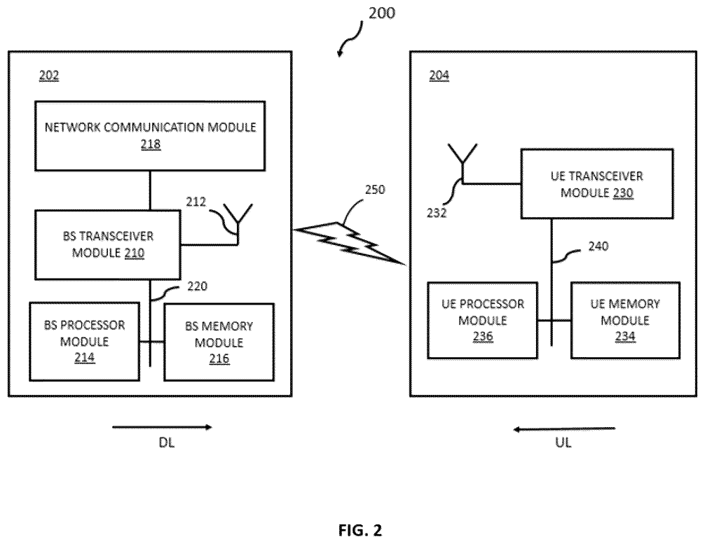

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Resource Configuration for Network Nodes

In 3GPP, Release-18 (e.g., a network node, a network-controlled repeater (NCR)) is introduced as an enhancement over conventional radio frequency (RF) repeaters with a capability to receive and process side control information from a network. The network node may include but not limited to a network-controlled repeater (NCR), a smart repeater (SR), an enhanced RF repeater, a reconfiguration intelligent surface (RIS), or an integrated access and backhaul (IAB). The network node can be denoted as a smart node (SN) for simplicity. A SN can be a kind of network node to assist BS to improve coverage. The SN may forward common channels/signals from a BS/UE to a UE/BS to assist data processing. The common channels/signals may be transmitted in different transmit (TX) beams of the BS/UE or with different transmission configuration indicator (TCI) states/indexes. For forwarding common channels/signals, there are some issues that the present disclosure recognizes and provides solutions to address, including determination of which common channels/signals from the BS/UE may be forwarded to the UE/BS by the SN, and/or mapping between common channels/signals from the BS/UE and SN beams. The systems and methods presented herein include a novel approach for resource configuration for network nodes.

Coverage can be a fundamental aspect of cellular network deployments. Mobile operators may rely on different types of network nodes to offer blanket coverage in the deployments. Therefore, new types of network nodes have been considered to increase mobile operators' flexibility for the network deployments. For example, integrated access and backhaul (IAB) was introduced in Release-16 and enhanced in Release-17 as a new type of network node not requiring a wired backhaul. Another type of network node is a RF repeater which may amplify-and-forward any received signals. The RF repeaters may have seen a wide range of deployments in 2G, 3G and 4G to supplement the coverage provided by regular full-stack cells. The RF repeater may only have a radio unit.

In Release-18, a network-controlled repeater is introduced as an enhancement over conventional RF repeaters with a capability to receive and process side control information from the network. The side control information may allow a network-controlled repeater to perform an amplify-and-forward operation in a more efficient manner. The advantages may include mitigation of unnecessary noise amplification, transmissions and receptions with better spatial directivity, and/or simplified network integration. The network-controlled repeater can be regarded as a stepping stone of re-configurable intelligent surface (RIS). A RIS node can adjust a phase and/or an amplitude of received signals to improve the coverage.

The smart node (SN)/network node can comprise two units to support different functions: a first unit and a second unit respectively. The first unit may receive and may decode side control information from a base station (BS). The first unit can be a communication/control unit (CU), a mobile terminal (MT), part of UE, and/or a third-party Internet of Things (IoT) device. The second unit may perform/conduct/carry out an intelligent amplify-and-forward operation using the side control information received by the first unit of the SN. The second unit can be a forwarding unit (FU), a radio unit (RU), and/or a RIS. In this disclosure, the smart node/network node may be simply referred as SN. The communication/control unit (CU) and the forwarding unit (FU) may be referred as the first unit of the SN and the second unit of the SN respectively.

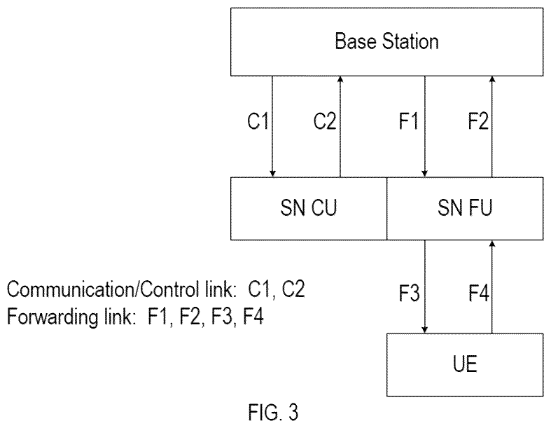

Referring now to FIG. 3, depicted is a configuration of an example of transmission links between a BS to a SN and a SN to a UE. C1 can be a communication link (or a control link) (CL) from the BS to the SN CU. C2 can be a communication link from the SN CU to the BS. F1 can be a forwarding link from the BS to the SN FU. F2 can be a forwarding link from the SN FU to the BS. F3 can be a forwarding link from the SN FU to the UE. F4 can be a forwarding link from the UE to the SN FU. In some embodiments, a communication link may mean/indicate a signal from one side (e.g., BS or SN CU) can be detected and be decoded by the other side (e.g., SN CU or BS). Information transmitting in the communication link can be utilized to control a status of forwarding links. A forwarding link may mean/indicate a signal from the BS or the UE can be unknown by the SN FU. The SN FU may simply amplify and forward signals without decoding the signals. F1+F3 is a complete DL forwarding link from the BS to the UE, in which F3 is the SN FU DL forwarding link. F2+F4 is a complete uplink (UL) forwarding link from the UE to the BS, in which F2 is the SN FU UL forwarding link.

In 3GPP series specifications, a beam can be implicitly represented by terms such as a quasi co location (QCL) relation/assumption/type, a transmission configuration indication (TCI) state, a spatial filter/parameter/relation, or a resource/SS/PBCH block (SSB) index. For example, a (maximum) number of beams is usually represented by a (maximum) number of QCL relation between SS/PBCH blocks (SSBs) or by a (maximum) number of SSB indexes. The SSB index can be numbered from 0. If the maximum number of beams or the maximum number of SSB indexes is Lₘₐₓ, the maximum index of SSB can be Lₘₐₓ−1. Same beam used for two or more channels/signals can be represented by same beam index, same QCL relation/assumption/type (e.g. type D), same TCI state, same spatial filter/parameter/relation, or same SSB index for these channels/signals. In this disclosure, above terms can be substituted for each other.

The SN may report a beam capability to the BS. For example, the beam capability may support up to four forwarding beams. The beam capability can include one or more of the following types: (1) a beam capability on links or units (e.g., a maximum number of SN downlink transmission beams (F3), a maximum number of SN uplink transmission beams (F2 or C2), a maximum number of SN downlink reception beams (F1 or C1), a maximum number of SN uplink reception beams (F4), a maximum number of forwarding link (or forwarding unit) beams (F1/F2/F3/F4), a maximum number of control link (or control unit) beams (C1/C2), or one or more combinations of the above); (2) a beam capability on timing-related (e.g., a beam switching time, a number of beam switching in a time unit, a beam report time, a beam application time, and/or a time delay from RX/TX to TX/RX); (3) a beam capability on beam characteristic (e.g., a beam correspondence, a beam width (narrow or wide), and/or a beam direction); (4) a beam capability on signals/channels (e.g. a maximum number of beams for a SS/PBCH block (SSB), a channel state information reference signal (CSI-RS), a sounding reference signal (SRS), a demodulation reference signal (DMRS), and/or a tracking reference signal (TRS)); (5) a beam capability on behaviors (e.g., a beam switching, a beam measurement, a beam reporting, and/or a periodic/aperiodic/semi-static measurement/reporting).

Operations, administration, and maintenance (OAM) or the BS may configure the information for the SN RX/TX to the SN. The information for the SN receive/transmit (RX/TX) may include the information of beams at the SN side (e.g., a number of beams, a beam index, a beam direction, a beam width (narrow or wide), a beam usage sequence, a beam position in time-domain, a beam usage pattern (e.g., transmit/not-transmit, use/not-use, period, offset, interval, or duration)). In some embodiments, the information for the SN RX/TX may include common channels/signals from the BS/UE needed/required to be forwarded to the UE/BS by the SN. A common channel/signal can be represented by an index of common channels/signals, an index of resource of common channels/signal, a TCI state, a spatial relation, or a beam. Common channels/signals can include a SSB, a CSI-RS, or a SRS. In some embodiments, the information for the SN RX/TX may include a mapping between common channels/signals from the BS/UE and beams at the SN side (e.g., mapping between a SSB index and beams at the SN side, mapping between a CSI-RS resource (resource set) and beams at the SN side). A common channel/signal can be represented by an index of common channels/signals, an index of resource of common channels/signal, a TCI state, a spatial relation, or a beam. Common channels/signals can include a SSB, a CSI-RS, or a SRS. In some embodiments, the information for the SN RX/TX may include a mapping between a system frame number (SFN) (or slot number) and beams at the SN side.

Configurations for the SN indicated by the OAM or the BS in this disclosure can be carried through system information, a Radio Resource Control (RRC) signalling, a medium access control control element (MAC CE) signaling, or a Downlink Control Information (DCI) signalling. If indicated by a DCI signaling, the configurations can be scrambled by a new SN specific, link specific, service-type specific, or SN logic unit specific radio network temporary identifier (RNTI). In certain embodiments, “beams at the SN side” may refer to the SN TX beams or RX beams (e.g., the SN DL TX/forwarding beam (F3 link in FIG. 1)). In some embodiments, the beam here can be replaced by other terms mentioned above.

Information for the SN RX/TX can be determined by the SN according to predefined rules without OAM or BS configuration. For example, the number of beams can be equal to a SN beam capability. For example, a mapping between a system frame number (SFN) (or slot number) and beams at the SN side can be operated by the SN according to predefined rules.

For determining whether common channels/signals from the BS/UE need to be forwarded to the UE/BS by the SN, there can be four methods corresponding to implementation example 1 to implementation example 4 (e.g., method 1 to method 4).

### A. Method 1

The OAM or the BS may configure which common channels/signals from the BS/UE need to be forwarded by the SN. The OAM or the BS may configure the information to the SN through system information, a RRC signaling, a MAC CE or a DCI signaling (e.g., configure a new 1^{st} bitmap to the SN). In some embodiments, the OAM or the BS may configure a relationship between the configuration of the common channels/signals and a configuration of the BS to the UEs, including the SN (e.g., the relationship between 1^{st} bitmap and 2^{nd} bitmap (ssb-PositionsInBurst in SIB1 or ServingCellConfigCommon)). There can be three schemes: Scheme 1-1, Scheme 1-2, and Scheme 1-3. In some embodiments, the OAM or the BS may configure other requirements/restrictions of above configuration.

### B. Method 2

Common channels/signals can be forwarded by the SN in a periodic-sweeping way. In a period of a half frame with SSBs, the SN may use a same beam to forward the common channels/signals from the BS/UE to the UE/BS. In different periods of the half frame, the SN may use different beams to forward common channels/signals from the BS/UE to the UE/BS. SN beam index=└SFN/P┘ mod N. SFN is a system frame number. Each frame is equal to 10 ms. P is a period of a half frame with SSBs. N is the number of SN beams (e.g. for forwarding link). The information of beams at the SN side can be configured by the OAM or the BS.

### C. Method 3

The OAM or the BS may configure the SN with a threshold value. The threshold value can be used for assisting the SN to select common channels/signals for forwarding. If measurement results of the common channels/signals are greater than or equal to the threshold value, the SN may forward the common channels/signals. If measurement results of T common channels/signals are greater than or equal to the threshold value, and N is the number of the SN beams according to the SN beam capability or the configuration of the OAM/BS, the SN may select min (T, N) common channels/signals with the highest measurement results for forwarding.

### D. Method 4

The SN may perform measurement and decide which common channels/signals for forwarding. For example, the SN may select N common channels/signals with highest measurement results for forwarding. N can be the number of the SN beams according to the SN beam capability or the configuration of the OAM/BS.

### Implementation Example 1

In some embodiments, the OAM or the BS may configure which common channels/signals from the BS/UE need to be forwarded by the SN. The OAM or the BS may configure information of the common channels/signals to the SN. A common channel/signal can be represented by an index of a common channel/signal, an index of resource of a common channels/signal, a TCI state, a spatial relation, or a beam. Common channels/signals can include a SSB, a CSI-RS, or a SRS. The OAM or the BS can configure the index of the common channel/signal, the index of resource of the common channel/signal, the TCI state index, the spatial relation index, or the beam index corresponding to the common channel/signal to the SN.

The OAM or the BS can configure the above information to the SN through system information, a RRC signaling, a MAC CE, or a DCI signaling. If indicated by a DCI signaling, the information can be scrambled by a new SN specific, link specific, service-type specific, or SN logic unit specific RNTI. In the existing 3GPP specifications, a bitmap of ssb-PositionsInBurst (in SIB1 or ServingCellConfigCommon) can be defined to indicate time domain positions of SSBs in a half frame and whether these SSBs can be transmitted at the time positions. For configuring which common channels/signals from the BS/UE need to be forwarded by the SN, there can be three schemes as follows.

Scheme 1-1: Common channels/signals to be forwarded configured by the OAM/BS may be a subset of common channels/signals configured by the BS to the UEs, including the SN. The common channels/signals configured by the BS to the UEs can be transmitted by the BS to the UEs. For example, the SSBs to be forwarded configured by the OAM/BS may be a subset of the SSBs indicated by the bits of “1” in the bitmap of ssb-PositionsInBurst. In other words, for the SSBs indicated by the bit of “0” in the bitmap of ssb-PositionsInBurst, the OAM/BS cannot indicate that the SSBs need to be forwarded by the SN. Alternatively, common channels/signals to be forwarded configured by the OAM/BS may at least include a common channel/signal corresponding to a best downlink transmission beam from the BS to the SN, a common channel/signal associated with a physical random access channel (PRACH) transmitted by the SN, or a best downlink transmission beam from the BS to the SN identified by the SN (e.g., SN CU).

Scheme 1-2: Common channels/signals to be forwarded configured by the OAM/BS may at least include the common channel/signal corresponding to a best downlink transmission beam from the BS to the SN, the common channel/signal associated with the PRACH transmitted by the SN, or the best downlink transmission beam from the BS to the SN identified by the SN (SN CU). For other common channels/signals to be forwarded configured by the OAM/BS, the other common channels/signals may be different from common channels/signals configured by the BS to the UEs, including the SN. For example, only one SSB among SSBs to be forwarded configured by the OAM/BS can be the same as one SSB among SSBs indicated by the bits of “1” in the bitmap of ssb-PositionsInBurst.

Scheme 1-3: Common channels/signals configured by the BS to the UEs, including the SN, cannot be configured by the OAM/BS. The common channels/signals may need to be forwarded by the SN. For example, the SSBs indicated by the bits of “1” in the bitmap of ssb-PositionsInBurst cannot indicate that the SSBs need to be forwarded by the SN.

In the following part, a SS/PBCH block (SSB) is taken as an example for common channels/signals. In some embodiments, the OAM or the BS may configure a 1^{st} bitmap to the SN, which can be used for indicating common channels/signals (e.g. SSB) from the BS/UE needed to be forwarded to the UE/BS by the SN. The bit width of the 1^{st} bitmap may need to be greater than or equal to the maximum number of beams or SSB indexes at the BS, or the bit width of the 1^{st} bitmap may need to support indicating the information of all beams or SSBs in a half frame.

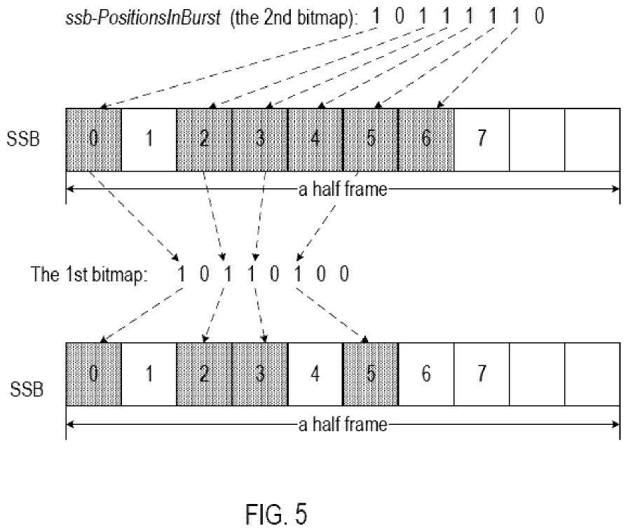

In a FR1 band, a maximum number of beams or SSB indexes that the BS can support can be 4 or 8. The bit width of the 1^{st} bitmap can be set as 4 or 8. In a FR2 band, a maximum number of beams or SSB indexes that the BS can support is 64. The bit width of the 1^{st} bitmap can be set as 64. Alternatively, the 1^{st} bitmap can be divided into two parts, each part is 8 bits with total of 16 bits. The first part can be used to indicate information of beams for groups, and the second part can be used to indicate information of beams in each group. The bit width of the 1^{st} bitmap can be equal to the bit width of ssb-PositionsInBurst (in SIB1 or ServingCellConfigCommon). In the 1^{st} bitmap, the bit of “1” can be used to indicate that the SSB in the corresponding time-position/beam from the BS or UE is needed to be forwarded by the SN, as shown in FIG. 5. The SN may consider or assume that the SSB corresponding to the bits of “0” in the 1^{st} bitmap may not need forwarding. In the 1^{st} bitmap, the number of bits of “1” may need to be less than or equal to the maximum number of beams at the SN side, which can be determined by a beam capability of the SN, or configured by the OAM/BS.

For Scheme 1-1, the bits of “1” in the 1^{st} bitmap may need to be a subset of the bits of “1” in the bitmap of ssb-PositionsInBurst (as shown in FIG. 5). The SSBs indicated by the bit of “1” in the 1^{st} bitmap may need to be a subset of the SSBs indicated by the bits of “1” in the bitmap of ssb-PositionsInBurst. For the SSBs indicated by the bit of “0” in the bitmap of ssb-PositionsInBurst, the 1^{st} bitmap cannot indicate the SSBs as needing the SN for forwarding. Alternatively, one bit among the bits of “1” in the 1^{st} bitmap at least may indicate the SSB corresponding to the best downlink transmission beam from the BS to the SN, the SSB associated with the PRACH transmitted by the SN, or the best downlink transmission beam from the BS to the SN identified by the SN (e.g., SN CU).

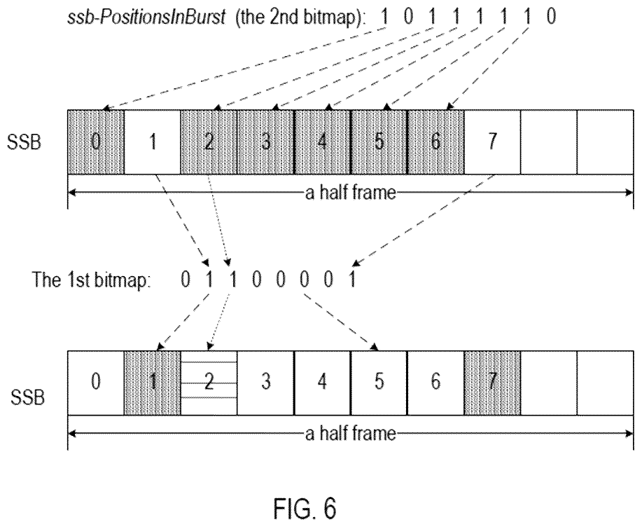

For Scheme 1-2, one bit among the bits of “1” in the 1^{st} bitmap may at least indicate the SSB corresponding to the best downlink transmission beam from the BS to the SN, the SSB associated with the PRACH transmitted by the SN, or the best downlink transmission beam from the BS to the SN identified by the SN (e.g., SN CU). For other bits of “1” in the 1^{st} bitmap, the bits at the same positions in the bitmap of ssb-PositionsInBurst cannot be set as “1”, and vice versa. In other words, only one SSB indicated by the bits of “1” in the bitmap of ssb-PositionsInBurst and the 1^{st} bitmap can be the same (as shown in FIG. 6).

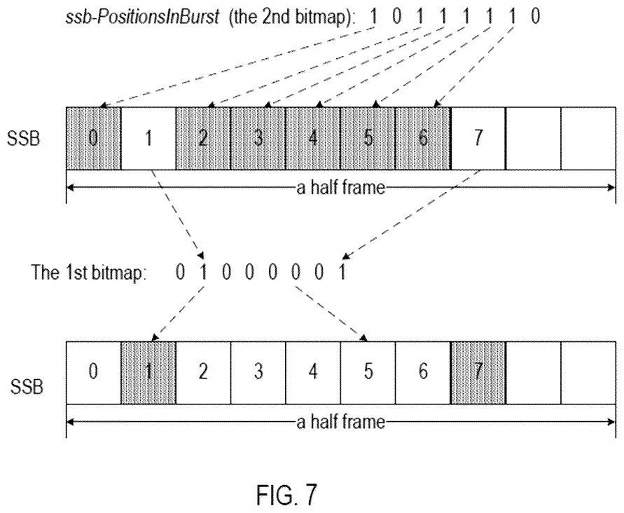

For Scheme 1-3, the SSBs indicated by the bits of “1” in the bitmap of ssb-PositionsInBurst cannot be indicated by the bits of “1” in the 1^{st} bitmap. For the SSBs indicated by the bit of “1” in the bitmap of ssb-PositionsInBurst, the 1^{st} bitmap cannot indicate the SSBs as needing the SN for forwarding (as shown in FIG. 7).

For example, the SN may report that the maximum number of beams it supports is 4 (e.g. for forwarding link). The 1^{st} bitmap for the SN configured by the OAM or the BS is {1, 0, 1, 1, 0, 1, 0, 0}. The number of bits of “1” in the 1^{st} bitmap is 4, which is equal to the maximum capacity of 4 beams that the SN can support. The above bitmap indicates that the SN needs to forward common channels/signals received on the BS beams number 0, 2, 3, and 5. In other words, the above bitmap indicates that the SN needs to forward SSB index number 0, 2, 3, and 5 received from the BS.

For example, the SN may report that the maximum number of beams it supports is 4 (e.g. for forwarding link). The 1^{st} bitmap for the SN configured by the OAM or the BS is {1, 0, 1, 1, 0, 0, 0, 0}. The number of bits of “1” in the 1^{st} bitmap is 3, which is less than the maximum capacity of 4 beams that the SN can support. The above bitmap indicates that the SN needs to forward common channels/signals received on the BS beams number 0, 2, and 3. In other words, the above bitmap indicates that the SN needs to forward SSB index number 0, 2, and 3 received from the BS.

For example, the BS may configures a 2^{nd} bitmap of ssb-PositionsInBurst (in SIB1 or ServingCellConfigCommon) to the SN or the UE to indicate the information of beams or SSBs transmitting from the BS. For ssb-PositionsInBurst in ServingCellConfigCommon, the BS may indicate that the 2^{nd} bitmap of ssb-PositionsInBurst is {1, 0, 1, 1, 1, 1, 1, 0}. The 2^{nd} bitmap may indicate that the BS transmits beams number 0, 2, 3, 4, 5, and 6 (or SSB index number 0, 2, 3, 4, 5, and 6). In some embodiments, the SN may report that the maximum number of beams it supports is 4 (e.g. for forwarding link). The 1^{st} bitmap for the SN configured by the OAM or the BS is {1, 0, 1, 1, 0, 1, 0, 0}. The bits of “1” in the 1^{st} bitmap may need to be a subset of the bits with “1” in the 2^{nd} bitmap. Alternatively, the SSBs indicated by the bit of “1” in the 1^{st} bitmap may need to be a subset of the SSBs indicated by the bits of “1” in the bitmap of ssb-PositionsInBurst. Alternatively, for the SSBs indicated in the 2^{nd} bitmap that it may not be transmitted (the SSBs corresponding to the bits of “0” in the 2^{nd} bitmap), the 1^{st} bitmap cannot indicate the SSBs as needing the SN for forwarding. The number of bits of “1” in the 1^{st} bitmap is 4, which is equal to the maximum capacity of 4 beams that the SN can support. The 1^{st} bitmap may indicate that the SN needs to forward common channels/signals received on the BS beams number 0, 2, 3, and 5. The 1^{st} bitmap may indicate that the SN needs to forward SSB index number 0, 2, 3, and 5 received from the BS.

### Implementation Example 2

In some embodiments, common channels/signals can be forwarded by the SN in a periodic-sweeping way. In a period of a half frame with SSBs, the SN may use a same beam to forward one or more the common channels/signals from the BS to the UE, even if the common channels/signals may be transmitted on the different beams of the BS. In different periods of the half frame, the SN can use different beams to forward common channels/signals from the BS to the UE. For example, the period of the half frame with SSBs is 20 ms and the number of forwarding beams of the SN is 4. In the first 20 ms period, the SN may use beam 0 to forward 64 (it can also be other values from 1 to Lmax) SSBs sent in the half frame by the BS. The 64 SSBs can be located in 64 different beams and may have different SSB indexes or candidate SSB indexes. In the second 20 ms period, the SN may use beam 1 to forward 64 SSBs sent in the half frame by the BS. The 64 SSBs can be located in 64 different beams and may have different SSB indexes or candidate SSB indexes. In the third 20 ms period, the SN may use beam 2 to forward 64 SSBs sent in the half frame by the BS. The 64 SSBs can be located in 64 different beams and may have different SSB indexes or candidate SSB indexes. In the fourth 20 ms period, the SN may use beam 3 to forward 64 SSBs sent in the half frame by the BS. The 64 SSBs can be located in 64 different beams and may have different SSB indexes or candidate SSB indexes. In the fifth 20 ms period, the SN may use beam 0 again to forward 64 SSBs sent in the half frame by the BS. The 64 SSBs can be located in 64 different beams and may have different SSB indexes or candidate SSB indexes.

The period of beam sweeping at the SN side can be actually equal to the period of the half frame with SSBs at the BS side multiplied by the number of beams of the SN (e.g. forwarding link). In above example, the period of beam sweeping at the SN side is 20 ms×4=80 ms.

In some embodiments, the SN beam (e.g. for forwarding link) can be determined by the following schemes. Scheme 2-1: SN beam can be determined by one or more of the following parameters: a system frame number (SFN), a slot number, a period of a half frame with SSBs, and/or a number of beams of the SN. For example, if the period of the half frame is more than or equal to 10 ms, SN beam index=└SFN/P┘ mod N. SFN is a system frame number. Each frame is equal to 10 ms. P is the period of the half frame with SSBs. The unit of P is 10 ms. P =2 indicates the period of the half frame is 20 ms. N is the number of SN beams (e.g. for forwarding link), which can be configured by the OAM or the BS, or can be determined by the SN itself (according to the beam capability). The above SN beam index is indexed from 0. If starting indexing from 1, the right of the equation needs to be added with 1. If the period of the half frame is equal to 5 ms (within each 10ms), the indexes of two SN beams are respectively: {SFN*2 mod N; (SFN*2 mod N)+1}.

Scheme 2-2: SN beam can be configured by the OAM or the BS. As given above, the OAM or the BS may configure the information of beams at the SN side (i.e. SN beams) including at least one of the following: a number of beams, a beam index, a beam direction, a beam width (narrow or wide), a beam usage sequence, a beam position in time-domain, a beam usage pattern (e.g., transmit/not-transmit, use/not-use, period, offset, interval, and/or duration).

### Implementation Example 3

In some embodiments, the OAM or the BS may configure the SN with a threshold value. The threshold value can be used for assisting the SN to select common channels/signals for forwarding. If measurement results of the common channels/signals are greater than or equal to the threshold value, the SN may forward the common channels/signals. If measurement results of T common channels/signals are greater than or equal to the threshold value, and N is the number of the SN beams according to the SN beam capability or the configuration of the OAM/BS, the SN may select min (T, N) common channels/signals with the highest measurement results for forwarding.

For example, the BS may configure the SN with a threshold value: THₘᵢₙ, and may transmit 8 SSBs in 8 beams respectively in a half frame to the SN. The SN may perform measurement for each SSB. Among the 8 SSBs, the measurements results of 3 SSBs are greater than or equal to THₘᵢₙ, the SN may select the 3 SSBs and forwards them to the UE. Furthermore, if the number of available beams is 2, the SN may select top 2 SSBs with highest measurement results for forwarding.

### Implementation Example 4

In some embodiments, the SN may perform measurement (e.g. RSRP-based measurement) and may decide which common channels/signals for forwarding by itself. For example, the SN may select N common channels/signals with the highest measurement results for forwarding. N can be a number of the SN beams according to a SN beam capability or a configuration of the OAM/BS.

### Implementation Example 5

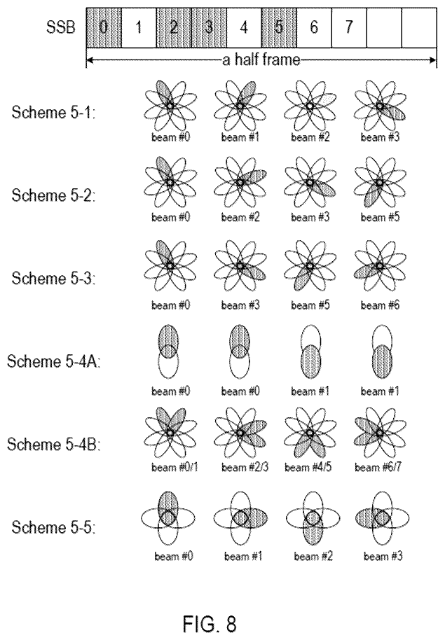

For mapping between common channels/signals from the BS/UE and the SN beams, there can be four schemes as follows. Scheme 5-1: The index of the SN beams may correspond to the index of common channels/signals to be forwarded in ascending order. The index of common channels/signals can also be represented by the index of a resource, a TCI state, a spatial relation, or a beam of the common channels/signal. As shown in FIG. 8, the index of the SN beams may correspond to the order of the bits of “1” in the 1^{st} bitmap in turn. The SN may support 8 forwarding beams. The SN beam number 0, 1, 2, and 3 may correspond to the BS beams number 0, 2, 3, and 5 respectively. The SN may use beam number 0, 1, 2, and 3 to forward SSB number 0, 2, 3, and 5 respectively. If the maximum number of the SN beams is greater than the number of common channels/signals (e.g. the bits of “1” in 1^{st} bitmap), the remaining SN beams may not need to forward common channels/signals. The configuration of the OAM/BS for the SN may need to ensure/verify that the number of the SN TX beams and the number of TCI states (or beams/indexes) of common channels/signals to be forwarded are the same or matched.

Scheme 5-2: The index of the SN beams can be the same as the index of common channels/signals to be forwarded. As shown in FIG. 8, the index of the SN beams can be the same as the index of the BS beams or SSBs. The SN may use beam number 0, 2, 3, and 5 to forward SSB number 0, 2, 3, and 5 respectively. The number of the SN beams may be equal to or matched with that of the BS.

Scheme 5-3: The index of the SN beams can be configured by the OAM or the BS for forwarding common channels/signals. As shown in FIG. 8, the OAM or the BS may configure the SN beam number 0, 3, 5, and 6 to forward SSB number 0, 2, 3, and 5.

Scheme 5-4: X common channels/signals may correspond to Y SN beams. For example, one, two, or four common channels/signals may correspond to one same SN beam. This scheme can be mainly used/applied in the case of more channels/signals to be forwarded and less SN beams. As shown in FIG. 8 (Scheme 5-4A), the SN only supports two forwarding beams but has four SSBs to be forwarded, so the SN may use beam number 0 to forward SSB number 0, and 2; and the SN uses beam number 1 to forward SSB number 3, and 5. For another example, one common channel/signal may corresponds to one, two or four SN beams. This scheme can be mainly used/applied in the case of less channels/signals to be forwarded and more SN beams. As shown in FIG. 8 (Scheme 5-4B), the SN may support eight forwarding beams but only has four SSBs to be forwarded, so the SN may use beam number 0 and 1 to forward SSB number 0; beam number 2 and 3 to forward SSB number 2; beam number 4 and 5 to forward SSB number 3; beam number 6 and 7 to forward SSB number 5. The mapping between X common channels/signals and Y SN beams can be configured by the OAM or the BS, or determined by the SN according to its beam capability.

Scheme 5-5: The SN may use wide or narrow beams to forward common channels/signals. For example, the SN may support 8 narrow beams or 4 wide beams. If there are 4 SSBs to be forwarded, the SN can use 4 wide beams to forward 4 SSBs respectively (as shown in FIG. 8). If there are 8 SSBs to be forwarded, the SN can use 8 narrow beams to forward 8 SSBs respectively. Whether the SN uses wide or narrow beams can be configured by the OAM/BS, or determined by a SN beam capability. Scheme 5-6: The combination of above scheme one or more.

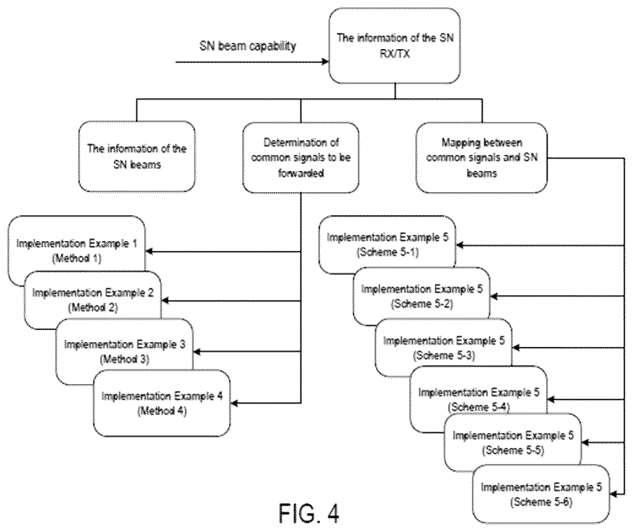

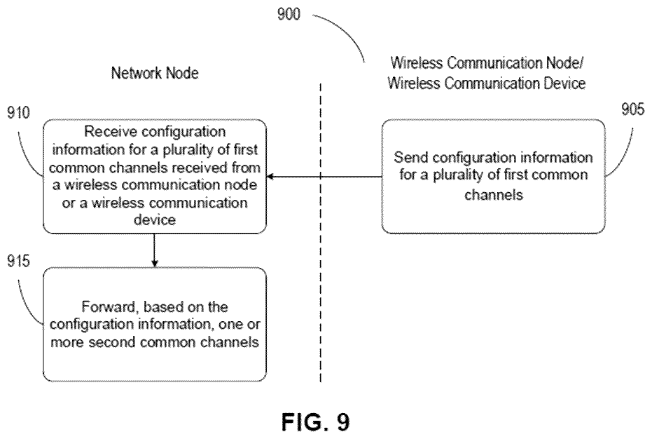

FIG. 9 illustrates a flow diagram of a method 900 for resource configuration for network nodes. The method 900 may be implemented using any of the components and devices detailed herein in conjunction with FIGS. 1-8. In overview, the method 900 may include receiving configuration information for a plurality of first common channels received from a wireless communication node or a wireless communication device. The method 900 may include forwarding, based on the configuration information, one or more second common channels.

Referring now to operation (910), and in some embodiments, a network node may receive configuration information for a plurality of first common channels received from a wireless communication node (e.g., a ground terminal, a base station, a gNB, an eNB, or a serving node) or a wireless communication device (e.g., a user equipment). Referring now to operation (915), the network node may forward one or more second common channels based on the configuration information.

In some embodiments, the network node may receive the configuration information from the wireless communication node through a signalling comprising at least one of: system information, a Radio Resource Control (RRC) signalling, a medium access control control element (MAC CE) signaling, or a Downlink Control Information (DCI) signalling. The signalling, through one or more bitmaps, may indicate that the one or more second common channels can be a subset of the plurality of first common channels. The signalling, through one or more bitmaps, may indicate that the one or more second common channels each may correspond to at least one of: a best downlink transmission beam from the wireless communication node to the network node, one of the first common channels associated with a Physical Random Access Channel (PRACH) transmitted by the network node, or a best downlink transmission beam from the wireless communication node to the network node identified by the network node. The signalling, through one or more bitmaps, may indicate that one or more second common channels can be excluded from the first common channels.

In some embodiments, the one or more second common channels may represent all the first common channels. The network node may forward the one or more second common channels within each of a plurality of periods, wherein the periods each may correspond to a half frame containing the first common channels. The network node may forward the one or more second common channels within each period using a respective beam. The beam can be associated with an index determined based on a system frame number, the period, and a number of frames. The beam can be configured by the wireless communication node or an operations administration and maintenance (OAM) unit.

In some embodiments, the network node may determine the one or more second common channels based on comparing respective measurement results of the first common channels with a threshold value, wherein the threshold value can be configured by the wireless communication node or an OAM unit. The network node may determine the one or more second common channels based on respective measurement results of the first common channels. The network node may determine a plurality of beams to forward the one or more second common channels, respectively, wherein indices of the plurality of beams may correspond to indices of the one or more second common channels arranged in an ascending order, respectively.

In some embodiments, the network node may determine a plurality of beams to forward the one or more second common channels, respectively, wherein indices of the plurality of beams can be identical to indices of the one or more second common channels, respectively. The network node may use a plurality of beams to forward the one or more second common channels, respectively, wherein indices of the plurality of beams can be configured by the wireless communication node or an OAM unit. The network node may use a single beam to forward a subset of the one or more second common channels. The network node may one or more beams to forward a corresponding one of the one or more second common channels. The network node may use a plurality of narrow or wide beams to forward the one or more second common channels, respectively.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software” module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A wireless communication method, comprising:
receiving, by a network node, configuration information for a plurality of first common channels received from a wireless communication node or a wireless communication device; and
forwarding, by the network node, based on the configuration information, one or more second common channels.

2. The wireless communication method of claim 1, further comprising receiving, by the network node, the configuration information from the wireless communication node through a signalling comprising at least one of: system information, a Radio Resource Control (RRC) signalling, a medium access control control element (MAC CE) signaling, or a Downlink Control Information (DCI) signalling.

3. The wireless communication method of claim 2, wherein the signalling, through one or more bitmaps, indicates that the one or more second common channels are a subset of the plurality of first common channels.

4. The wireless communication method of claim 2, wherein the signalling, through one or more bitmaps, indicates that the one or more second common channels each correspond to at least one of: a best downlink transmission beam from the wireless communication node to the network node, one of the first common channels associated with a Physical Random Access Channel (PRACH) transmitted by the network node, or a best downlink transmission beam from the wireless communication node to the network node identified by the network node.

5. The wireless communication method of claim 2, wherein the signalling, through one or more bitmaps, indicates that one or more second common channels are excluded from the first common channels.

6. The wireless communication method of claim 1, wherein the one or more second common channels represent all the first common channels.

7. The wireless communication method of claim 6, further comprising forwarding, by the network node, the one or more second common channels within each of a plurality of periods, wherein the periods each correspond to a half frame containing the first common channels.

8. The wireless communication method of claim 7, further comprising forwarding, by the network node, the one or more second common channels within each period using a respective beam.

9. The wireless communication method of claim 8, wherein the beam is associated with an index determined based on a system frame number, the period, and a number of frames.

10. The wireless communication method of claim 8, wherein the beam is configured by the wireless communication node or an operations administration and maintenance (OAM) unit.

11. The wireless communication method of claim 1, further comprising determining the one or more second common channels based on comparing respective measurement results of the first common channels with a threshold value, wherein the threshold value is configured by the wireless communication node or an OAM unit.

12. The wireless communication method of claim 1, further comprising determining the one or more second common channels based on respective measurement results of the first common channels.

13. The wireless communication method of claim 1, further comprising determining, by the network node, a plurality of beams to forward the one or more second common channels, respectively, wherein indices of the plurality of beams correspond to indices of the one or more second common channels arranged in an ascending order, respectively.

14. The wireless communication method of claim 1, further comprising determining, by the network node, a plurality of beams to forward the one or more second common channels, respectively, wherein indices of the plurality of beams are identical to indices of the one or more second common channels, respectively.

15. The wireless communication method of claim 1, further comprising using, by the network node, a plurality of beams to forward the one or more second common channels, respectively, wherein indices of the plurality of beams are configured by the wireless communication node or an OAM unit.

16. The wireless communication method of claim 1, further comprising using, by the network node, a single beam to forward a subset of the one or more second common channels.

17. The wireless communication method of claim 1, further comprising:
using, by the network node, one or more beams to forward a corresponding one of the one or more second common channels or
using, by the network node, a plurality of narrow or wide beams to forward the one or more second common channels, respectively.

18. A network node, comprising:
at least one processor configured to:
receive, via a transceiver, configuration information for a plurality of first common channels received from a wireless communication node or a wireless communication device; and
forward, via the transceiver, based on the configuration information, one or more second common channels.

19. A wireless communication method, comprising:
sending, by a wireless communication node to a network node, configuration information for a plurality of first common channels received from the wireless communication node or a wireless communication device; and
causing the network node to forward, based on the configuration information, one or more second common channels.

20. A wireless communication node, comprising:
at least one processor configured to:
send, via a transmitter to a network node, configuration information for a plurality of first common channels received from a wireless communication node or a wireless communication device; and
cause the network node to forward, based on the configuration information, one or more second common channels.
